(19) United States
(12) Patent Application Publication
(10) Pub. No.: US 2004/0217735 A1
(43) Pub. Date: Nov. 4, 2004

(54) Interleaved switching lead-acid battery equalizer

(76) Inventor: Ehsan Chitsazan, Cumming, GA (US)

Correspondence Address: ARRIS INTERNATIONAL, INC, 3871 LAKEFIELD DRIVE, SUWANEE, GA, 30024, US

(21) Appl. No.: 10/771,029

(22) Filed: Feb. 3, 2004

Related U.S. Application Data
(63) Continuation-in-part of application No. 10/141,045, filed on May 8, 2002.
(60) Provisional application No. 60/289,574, filed on May 8, 2001.
(60) Provisional application No. 60/444,529, filed on Feb. 3, 2003.

(51) Int. Cl. H02J 7/00

(52) U.S. Cl. 320/116

(57) ABSTRACT

A method and system for equalizing the voltage of batteries in a battery string to a desired voltage. An equal string current is drawn from the batteries of the battery string and redistributed as a plurality of secondary currents to each battery depending upon the comparative voltage of the individual batteries. A larger secondary current is provided to batteries having a low voltage and a smaller secondary current is provided to batteries having a high voltage. A transformer is provided electrically connected to the battery string having an input winding connected to the battery string such that it receives an equal string current from each battery. The transformer has a plurality of output windings having an equal turn ratio, each output winding in parallel with a battery of the battery string, to provide a secondary charging current to a battery in the battery string.

### CROSS-REFERENCE TO RELATED APPLICATION

This application claims the benefit of U.S. patent application Ser. No. 10/141,045, entitled “Switching Lead-Acid Battery,” filed May 8, 2002, which claims the benefit of priority to U.S. Provisional Patent Application Ser. No. 60/289,574 filed May 8, 2001, entitled “Switching Lead-Acid Battery Equalizer.” This application also claims priority to U.S. Provisional Patent Application Ser. No. 60/444,529, filed Feb. 3, 2003, entitled “Interleaved Switching Lead-Acid Battery Equalizer.

### TECHNICAL FIELD

The present invention relates to battery charger circuits and, more specifically, to a battery voltage equalizer for equalizing the voltage across each of a plurality of series connected charging batteries.

### BACKGROUND OF THE INVENTION

In order to obtain optimum life from lead-acid batteries, the batteries must be correctly charged. When a single charger is used to charge a string of batteries in series, it is unlikely that all of the batteries will receive proper charging, even if all of the batteries are brand new. As a result, some batteries may receive insufficient charge while others receive excess charge. Both of these conditions cause the premature failure of the batteries.

Typically, in series battery string applications, the charger monitors total string voltage rather than individual battery voltages. Because the total string voltage is the sum of the ideal individual battery charging voltages, one battery may receive insufficient charge while another is overcharged. Both overcharging and undercharging, caused by high and low float voltages respectively, damage the batteries and decrease the battery's life. Overcharging produces excessive heat that can cause the battery plates within the cells to buckle and shed their active material. Undercharging causes buildup of unwanted chemicals on the battery plates, reducing the battery's capacity and effective life. Unlike NiCad batteries, lead-acid batteries require constant charging with a float voltage level specified by the manufacturer. To prevent damage to the batteries, battery manufacturers typically recommend a charging voltage between 13.25 to 13.65 Volts at 25° C. during initial charging. However, except in the case of single-battery applications, this recommendation is rarely observed. To complicate matters, the requirements for a given battery also vary with temperature. For example, MK batteries recommend −16.2 mV adjustment to the float voltage for one ° C. temperature change.

In a conventional battery charging circuit, a battery charger may be connected in series with a plurality of batteries. For example, as shown in FIG. 1, utilizing three batteries, battery A, battery B, and battery C, 110, 120, 130 connected in series with a battery charger 105. In this example, a 41.1 V battery charger 105 is intended to provide a float voltage of 13.7 V on each battery A, B, and C. When the charging cycle starts, a charge current is supplied to all of the discharged batteries in series. In constant voltage charging, the total string voltage is monitored to determine if all of the batteries have reached the required float voltage. In this example, the required float voltage for each battery is 13.7 V. The charging circuit will operate in float mode when total battery string voltage is 41.1 V (3 * 13.7V). However, if the batteries have uneven float voltages, as is nearly always the case, then the batteries will not receive the proper charge. For example, battery A may have a float voltage of 13.9 V while battery B has a float voltage of 13.5 V, and battery C has a float voltage of 13.7 V. The total string voltage is still 41.1V, but only battery C is being properly charged. In this example, battery A is being overcharged and battery B is not receiving adequate charge. Overcharging produces excessive heat which can damage the battery. Undercharging causes unwanted chemical buildup. Both of these problems reduce the life of the battery.

The float voltage is the voltage across a battery 110, 120, 130 while the battery 110, 120, 130 is charging in float mode or trickle mode. A typical battery charger 105 switches from normal charging mode to float mode or trickle mode once the charging battery or batteries 110, 120, 130 reach a full charge. In many systems, the typical operating mode is float mode or trickle mode. This is especially true for systems in which the batteries are used for backup power. In such systems, the batteries are fully charged except at initial start-up and following an interruption in the primary power source. In systems where the batteries are used to provide backup power, it is important that the batteries remain in a state of full charge so that the batteries are ready to provide power to the system until the main power supply is restored.

Typically, during the initial charging of a series of batteries to float mode as discussed above, a relatively large constant charging current is applied to the battery string for a relatively short period of time. For example, a charger may supply 10 amps of current for three hours to charge the battery string and reach float mode. Once the charger reaches float mode i.e., the desired string voltage is achieved, such as the 41.1 V string voltage in the example above, a large charging current is no longer needed. However, a small charging current, such as 0.6 amps, is typically applied in float mode to keep the batteries fresh and charged. Unlike the short time period of initial charging, however, the batteries may be charged in float mode for extended time periods such as several months or even years. During this extended time period the individual voltages of the batteries tend to vary, with some battery voltages moving higher than the desired float voltage and some voltages moving lower than the desired float voltage. This may occur even if the individual batteries are initially charged to their desired voltage. These voltage variances, even if not large, may damage the batteries over the extended time period.

To achieve equalization the plurality of batteries, a flyback transformer with multiple isolated outputs may be used. In such an approach, an equal string current is drawn from each battery of the battery string and redistributed to the batteries by a plurality of secondary charging currents based upon each battery's comparative voltage. Thus, the size of the secondary current provided to a particular battery varies inversely to the battery's comparative voltage, such that batteries with a lower voltage are provided with a larger secondary current and batteries with a higher voltage batteries are provided with a smaller secondary current. In this manner, the voltages of the batteries are equalized.

The total string voltage may be regulated by a charger to ensure that the total string voltage is maintained at a target voltage that is equal to the sum of the desired voltage of the plurality of batteries. Thus, as the total string voltage is maintained at the target voltage, the string current is redistributed unequally to the batteries such that the battery voltages become equalized at the same desired volt.

When using this technology, however, typical transformer design can present challenging limitation such as the following. First, the output windings cannot have large leakage inductance difference between them; otherwise, the required float voltage accuracy may not be achieved. Second, as the number of batteries in the string is increased (for example, in a golf car application, there are six batteries used in a series string to power the engine), the leakage inductance control becomes more and more difficult because of the number of windings involved. Third, small switching transformers used in these applications usually do not have large number of pins available to support more than three or four output windings, and therefore three or four batteries.

Therefore, there is a need in the art for a system and method for charging each of a plurality of batteries in a battery string to a desired voltage which is simple and energy efficient and which does not require the monitoring of individual battery voltages.

There is a further need in the art for a method and system using commonly available parts that can charge and equalize more than four batteries when using the string current to equalize the batteries.

### SUMMARY OF THE INVENTION

The present invention overcomes the above-described problems in the prior art by providing a system and method for charging a plurality of batteries in series to a desired voltage. The present invention also provides a system and method for equalizing the voltage of series connected batteries.

The method and system of the present invention is for use with a plurality of series connected batteries. In the present invention, an equal string current is drawn from each battery of the battery string and redistributed to the batteries by a plurality of secondary charging currents based upon each battery's comparative voltage. Thus, the size of the secondary current provided to a particular battery varies inversely to the battery's comparative voltage, such that batteries with a lower voltage are provided with a larger secondary current and batteries with a higher voltage batteries are provided with a smaller secondary current. In this way, the voltages of the batteries are equalized.

The total string voltage may be regulated by a charger to ensure that the total string voltage is maintained at a target voltage that is equal to the sum of the desired voltage of the plurality of batteries. Thus, as the total string voltage is maintained at the target voltage, the string current is redistributed unequally to the batteries such that the battery voltages become equalized at the same desired voltage.

In addition, an aspect overcomes the above-described problems in the prior art of being limited in the number of batteries that can be equalized/charged by a single equalizer/charger by interleaving secondary transformer circuits of two or more transformers with groups of batteries corresponding to the other transformer winding. In an aspect, one secondary circuit is shared between two battery groups to ensure that all batteries will obtain equal float voltages. In another aspect, the secondary of a first transformer corresponding to a first group of batteries is interconnected with a battery corresponding to a second group of batteries. Thus, complex and expensive transformer designs are avoided and a primary controller circuit can be shared between the two or more transformer circuits to minimize component cost and complexity.

Other objects, features, and advantages of the present invention will become apparent upon reading the following detailed description of the embodiments of the invention, when taken in conjunction with the accompanying drawings and appended claims.

### BRIEF DESCRIPTION OF THE DRAWINGS

FIG. 1 is a block diagram of a prior art charger.

FIG. 2 is a block diagram of an exemplary embodiment of the present invention.

FIG. 3 is a schematic diagram of an exemplary embodiment of a present invention.

FIG. 4 is a schematic diagram of exemplary embodiment of the present invention in an exemplary operating environment.

FIG. 5 is a plot of the voltage values of four batteries in float mode over time without the system of the present invention.

FIG. 6 is a plot of the voltage values of four batteries in float mode over time using the system of the present invention.

FIG. 7 illustrates a circuit for equalizing a string of batteries with two separate, serially-connected, transformer circuits.

FIG. 8 illustrates a circuit for equalizing a string of batteries with two separate, parrallel-connected, transformer circuits.

FIG. 9 illustrates a circuit for equalizing a string of batteries where secondary windings are interconnected between batery groups.

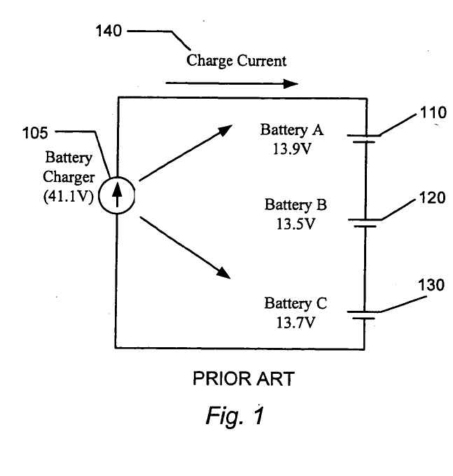

### DETAILED DESCRIPTION

The system of the present invention is for use with a plurality of series connected batteries. In the present invention, an equal string current is drawn from each battery of the string and redistributed unequally to each of the batteries as a plurality of secondary charging current based upon the comparative voltage of each individual battery, such that batteries with a lower voltage receive a larger secondary current and batteries with a higher voltage receive a smaller secondary current. In this way, each of the batteries is brought to the same voltage. By regulating the string voltage to a target voltage, each individual battery will approach a desired voltage.

The present invention provides a method for equalizing the voltage of batteries in a battery string to a desired voltage by providing a transformer electrically connected to the battery string. An equal string current is drawn from each battery of the battery string and provided to the transformer. The transformer provides a secondary current to each battery of the string inversely to the battery voltage, with batteries at a lower comparative voltage receiving more current than batteries at a higher comparative voltage.

In a preferred embodiment, the transformer has a primary winding, or coil, which is connected to the battery string such that it receives a string current drawn from each of the batteries. The string current induces a voltage in the primary winding, thereby creating a magnetic field in the transformer core.

The transformer has a plurality of secondary, or output, windings or coils connected to an output circuit, such that each output winding is in parallel relationship with a battery of the battery string. In a preferred embodiment, each output winding has the same turn ratio. Thus, when the transformer induces an output voltage in the output windings, the same voltage is induced in each of the windings because each has the same turn ratio. A secondary current is created in each output circuit to charge the respective battery in the particular output circuit. Because each output winding is parallel with its respective battery, the amount of current generated in a particular output circuit to charge the battery is dependent upon the voltage needs of the battery. Thus, each battery receives an amount of current in accordance with its needs based upon the comparative voltages of the other batteries in the string. In this way, the voltage of all of the batteries in the string are moved to the same voltage as current is redistributed from batteries at a higher voltage to batteries at a lower voltage.

In a preferred embodiment, a flyback transformer is used. A flyback transformer stores energy when the transformer is “on” and releases the stored energy to the output windings when the transformer is turned “off.” Such a flyback transformer may be arranged by controlling the polarity of the input and output windings and the direction of current flow, such as by the use of diodes, and by other means known in the art. Additional features may also be added to the system such as various switches, voltage monitors and regulators, current peak limiters, voltage regulators, dividers, etc. Furthermore, in addition to being used in conjunction with a plurality of series connected batteries, the present invention may be used with a single charging battery to achieve the same results.

Referring now to the drawings, in which like numerals refer to like parts throughout the several views, exemplary embodiments of the present invention are described in more detail.

Although the system will be described in terms of equalizing battery voltages during trickle or float mode when the charging current is relatively small, it will be recognized that the invention may also be used for initial charging of the battery.

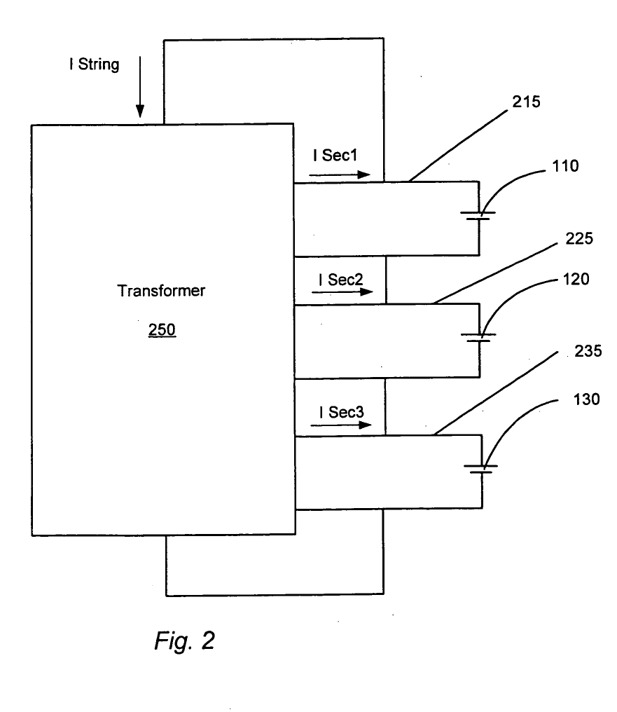

FIG. 2 shows a schematic diagram of a transformer 250 connected across a battery string. The transformer draws a string current I String from the batteries 110, 120, 130. The transformer provides a plurality of secondary current I Sec1, I Sec2, I Sec3 to charge the individual batteries through output circuits 215, 225, 235.

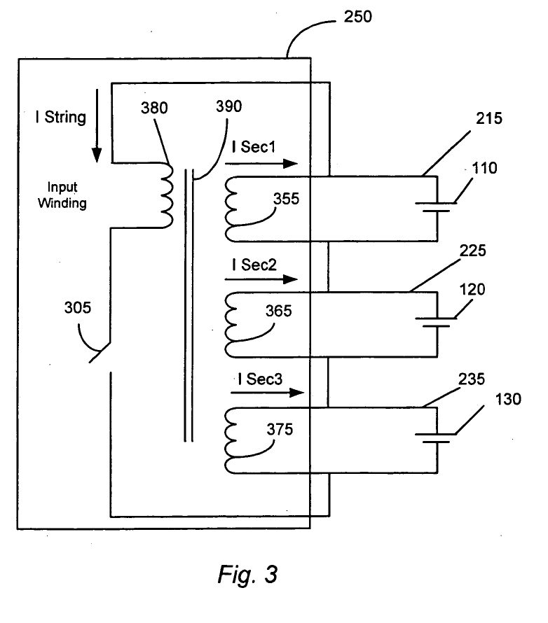

FIG. 3 is an illustration of an exemplary embodiment of the present invention. FIG. 3 shows a battery charging circuit including series connected batteries 110, 120, 130 connected with transformer 250 (shown in dotted line). As shown in FIG. 3, a plurality of output windings of the transformer, 355, 365, 375 are connected in parallel with each charging battery in an output circuit 215, 225, 235.

An input winding 380 of the transformer 250 is attached across the battery string such that it receives a string current I String. A voltage is thereby created in the input winding 380 and a magnetic field is created in the transformer core 390. A secondary voltage is induced by the electromagnetic field of the core 390 to each of the output windings 355, 365, 375 of the output circuits 115, 125, 135.

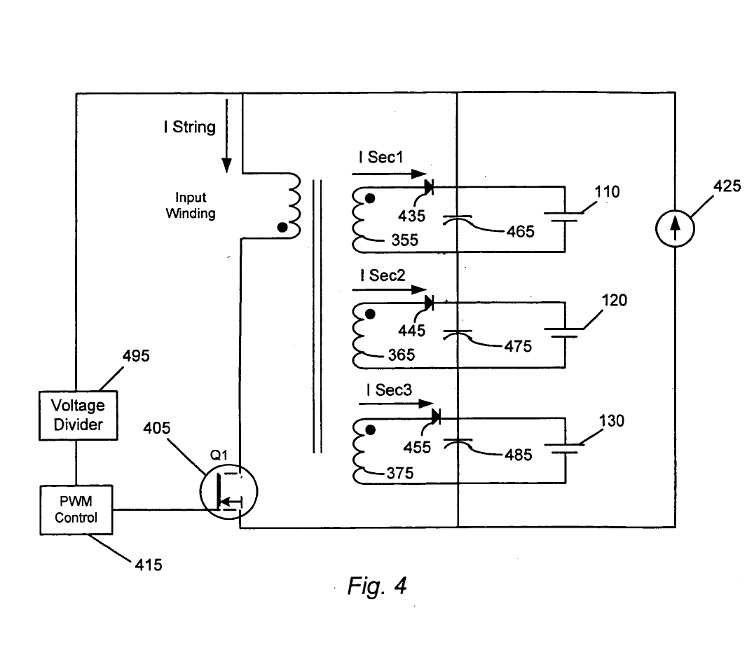

In a preferred embodiment, the turn ratio of each of the output windings is the same and therefore the same voltage is created in each output winding. A secondary current I Sec is created in the output circuits 115, 125, 135 to charge each respective battery according to its needs. As shown in FIG. 4, in a preferred embodiment, a flyback transformer is used. Thus, the transformer is turned “on” and “off” to store and release energy by a switch 405. When the transformer is “on,” current is fed into the input winding 380. Due to the opposite polarity of the input and output windings, and the direction of diodes 435, 445, 455 which prevent the flow of an induced current, the transformer does not induce a voltage in the secondary winding and current does not flow from the transformer to the output windings when the transformer is “on”, but the energy is stored in the transformer core 390 as an electromagnetic field. When the transformer is turned “off,” a voltage is induced in the output windings 355, 365, 375 and a secondary charging current I Sec1, I Sec2, I Sec3, flows from the output windings through the output circuits 215, 225, 235 to charge the respective battery 110, 120, 130.

The amount of current provided to each battery 110, 120, 130 is dependent upon the voltage needs of the battery. Thus, although the present system draws the same string current I String from each of the batteries 110, 120, 130 equally, it provides a secondary charging current I Sec to the batteries which varies depending upon the charging needs of the battery. The output windings 355, 365, 375, being in parallel relationship to the batteries 110, 120, 130 create a secondary current I Sec in the output circuits 115, 125, 135 to charge the respective battery in accordance with its comparative voltage to the other batteries, such that a battery at 1 lower voltage will receive a larger secondary current than a battery at a higher comparative voltage.

By way of example, assume the desired float voltage of each of the batteries 110, 120, and 130 is 13.7 volts, and the float voltage of one battery 110 is 13.1 V. When the transformer 150 is “on,” the voltage of the output winding 355 is also 13.1 V because it is in parallel with the battery and, due to the nature of a flyback transformer, the transformer does not induce a voltage while “on” but stores the energy in the transformer core. When the transformer is turned “off” a voltage is induced in the output winding from the energy stored in the transformer and a secondary current flows to charge the battery. For example, if a voltage of 13.7 V is induced in the output winding 355, a secondary current will flow from the output winding through the output circuit 215 to charge the battery which is at a lower voltage (13.1V).

If the voltage of a particular battery is higher than the voltage of another battery in the string, then that particular battery will receive less current than the other battery. On the other hand, if the voltage of a particular battery is less than another battery in the string, then that particular battery will receive more current than the other battery. For example, if the voltage of a battery 120 is 14.1 V, then the transformer will provide less current to that battery than a battery 110 having a lower comparative voltage of 13.1 V. By way of example only, if the string current draws 1 amp from each battery in the example above, the transformer will supply a larger secondary current I Sec1, such as 1.5 amps, to the battery 110 at the lower voltage (13.1 V) and a smaller secondary current I Sec2, such as 0.5 amps, to the battery 120 at the higher voltage (14.1 V). In this way, the system of the present invention redistributes the string current drawn equally from each battery to the batteries based upon each battery's individual voltage. As this process continues as the transformer is repeatedly turned “on” and “off”, the voltages of the batteries begin to equalize and approach the desired voltage.

As shown in FIG. 4, the transformer may be turned on and off by switch 405 as is known in the art. In addition, the current of the system may be regulated and controlled by various means, such as by a PWM controller 415. As shown in FIG. 4, capacitors 465, 475, 485 may be used for further controlling the voltage and storing charge. As also shown in FIG. 4, a charger 425 may be used to provide a charging current to the battery string. The charger 425 regulates the battery string voltage to ensure that it is at a target voltage. For example, if the desired charge for three batteries in a string is 13.7 V for each battery, the charger may be used to ensure the string voltage is 41.1 V.

The charger 425 may supply a charging current during float mode or initial charging. In a typical use of the invention, a plurality of battery voltage output circuits may be used to ensure that each battery of the string is charged to an equal voltage. A voltage divider 495 may be used to adjust the voltage. However, Applicant has found that a voltage divider is unnecessary where the charger 425 is used to ensure that the string voltage is correct. However, a voltage divider may be useful during the initial charging of the batteries where large currents are used.

By drawing an equal string current from all string batteries and providing a secondary charging current to the batteries, in accordance the voltage needs of each individual battery, the system equalizes the voltage of the batteries. The battery charger 425 regulates the total voltage across the series combination of the batteries. Because each battery 110, 120, 130 will be provided current in proportion to its needs, the batteries' voltages are equalized and they approach their desired voltage. In an exemplary embodiment of the present invention, the turn ratio of each output winding is the same.

It will be obvious to one of skill in the art that the present invention is not dependent upon the number of batteries in the string. Those skilled in the art will understand that the schematic of FIG. 4 is one implementation of the present invention and that numerous alternative implementations are available. Those skilled in the art will understand that the exact component values may need to be adjusted depending on the particular batteries being charged and the magnitude of the voltages and currents required and whether the system is used with initial charging, trickle mode, or both.

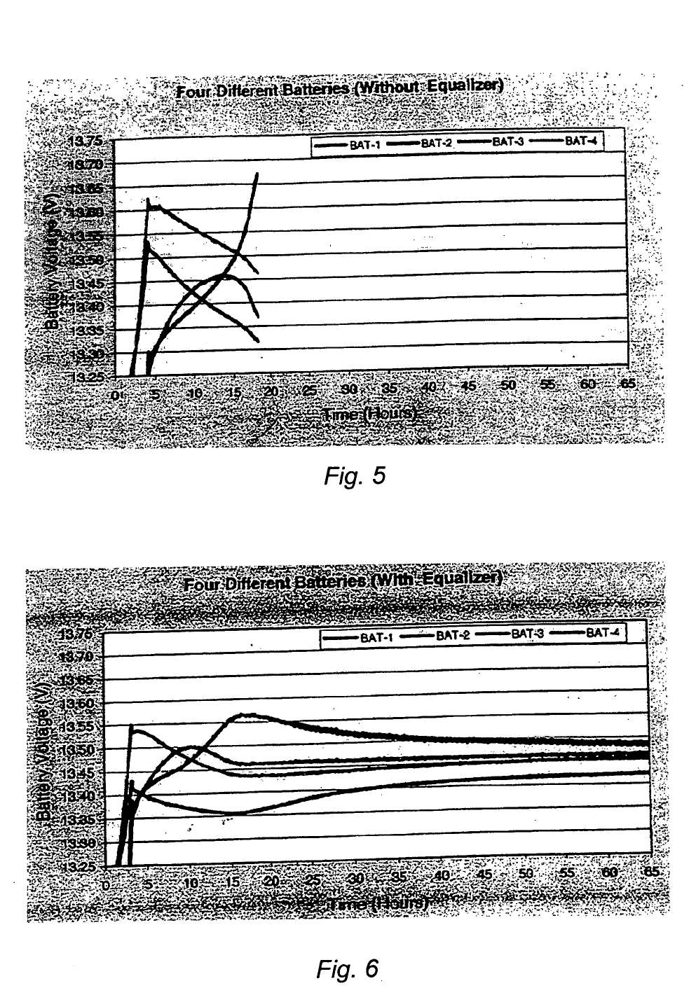

Battery manufacturers typically recommend a float voltage range of ±0.1 V of the recommended float voltage. FIG. 5 shows a plot of the float voltage values of four batteries in float mode over time without the equalizer system of the present invention. As can be seen, within a few hours the float voltages of the batteries have diverged by significantly more than ±0.1 V.

FIG. 6 shows a plot of the voltage values of four batteries in float mode over time using the method and system of the present invention. As can be seen, the voltages of the batteries converge to within ±0.1 V.

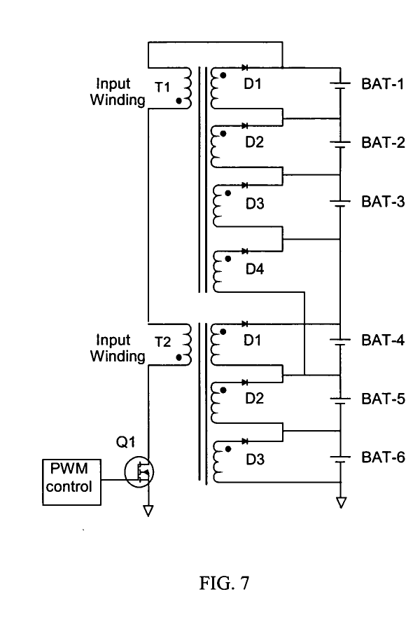

FIG. 7 shows a circuit for equalizing a string of batteries with two separate transformer circuits wherein the primaries thereof are serially-connected. The circuit uses two or more transformers connected in series to support a large number of batteries connected in series. Transformers T1 and T2 are shown, but it will be appreciated that more than two transforers can be connected to one another in the manner shown in the figure, to facilitate charging and equalization of more then eight batteries. To ensure that the regulated voltage of each of the plurality of batteries on multiple transformers is the same, a secondary winding is shared between adjacent transformer outputs. This couples the string current of the batteries associated with T1 with the string current of the batteries associated with T2. Therefore, all of the batteries BAT-1 through BAT-6 attain the same voltage when the batteries are equalized. If a charger/equalizer were used for batteries BAT-1 throught BAT-3, and another separate charger/equalizer were used for batteries BAT-4 through BAT-6, then it is possible, and likely, that the first group of batteries would attain a different end voltage than those of the second group, because of manufacturing and calibration variations between the two equalizer/chargers. By driving the input windings of T1 and T2 from a single switch and a single control circuit, complexity and cost are minumized, and charge equality of all the batteries BAT-1 through BAT-6 can be achieved.

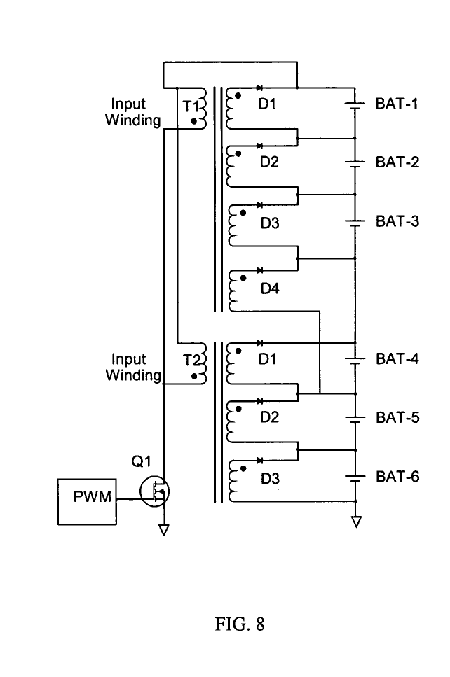

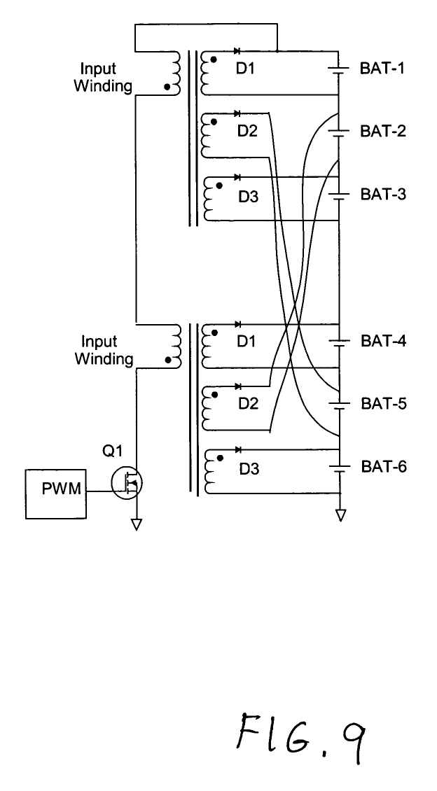

Turning now to FIG. 8, an interleaved battery equalizer is shown where the input circuits of two transformers, T1 and T2, are coupled to one another in a parallel fashion. The same advantages as described above with respect to FIG. 7 are achieved. It will be appreciated that the decision to use parallel or serial-connected transformers may be determined based on the target voltage of the string, or based on the physical or electrical (e.g. winding ratios) parameters of the transformers T1 and T2.

FIGS. 7 and 8 illustrate a six-battery-string application. However, the same approach can be taken for any number of batteries and corresponding transformer circuits. In the examples shown in FIGS. 7 and 8, the top transformer T1 corresponds to and equalizes the top three batteries, referred to as the first group, BAT-1, BAT-2 and BAT-3, by removing an equal amount of current from all batteries and providing each battery with a current inversely proportional to the battery voltage. If an individual battery voltage is lower than that of other batteries in the group of three, more current is supplied. This process continues until all three batteries are equalized. The bottom transformer T2 performs the same function with respect to the bottom three batteries, BAT-4, BAT-5, and BAT-6 until these batteries are equalized. As discussed above, winding D4 in this example is used as a bridge between the two groups of batteries to ensure that all batteries are equalized to a single voltage because all six batteries shown in the figure contribute equally to the string current, which is in turn distributed to all of the batteries to provide charging inversely proportional to each battery's respective voltage, as described above.

Instread of using a bridging winding D4, as shown in FIG. 7 and 8, FIG. 9 illustrates the secondary of a first transformer corresponding to a first group of batteries being interconnected with a battery corresponding to a second group of batteries and the secondary of a second transformer corresponding to a second group of batteries being interconnected with a battery of the first group of batteries. In the figure, secondary output winding, part of the group of windings corresponding to first group of batteries comprising BAT-1 through BAT-3, is shown parallel-connected in an output curcuit with BAT-5, and secondary output winding D2 of the second group of windings corresponding to the second group of batteries BAT-4 through BAT-6, is shown interconnected to BAT-2. This interconnection of windings and batteries provides the advantage that all the batteries BAT-1 through BAT-6 will be equalized to the same voltage, but the need for the bridging winding of the transformer corresponding to the first group of batteries, as shown in FIGS. 7 and 8, is eliminated. This also allows for the advantage that the primaries, or input windings of the first and second transformers can be connected in series or parallel, depending on the specific design requirements, and the advantage of using only one PWM controller (including Q1), or other type of controller is retained. It will be appreciated that the embodiments of FIGS. 7, 8 and 9 show two groups of batteries and corresponding transformers, but, the same principles shown in these drawings is applicable to more than two groups of batteries/transformers, as will be readily apparent to those skilled in the art.

This technology provides the advantage that more than three or four batteries can be equalized using the same equalizer circuitry. Thus, the need to purchase and operate multiple equalizers is eliminated, thereby saving cost, weight and space. Moreover, because a transformer and battery are interconnected, or interleaved, between groups, each battery being equalized is equalized to the same voltage, rather than all batteries of a particular group being equalized to the same voltage within the group, but not necessarily the same as the batteries of the other groups.

Although the system facilitates the equalizing of battery voltages during trickle or float mode when the charging current is relatively small, it will be recognized that the invention may also be used for initial charging of the battery.

One skilled in the art will appreciate that the schematics shown in FIGS. 7, 8 and 9 illustrate particular aspects and that numerous alternative implementations are available, including more or less batteries than shown in these preferred embodiments. Those skilled in the art will understand that the exact component values may need to be adjusted depending on the particular batteries being charged and the magnitude of the voltages and currents required and whether the system is used with initial charging, trickle mode, or both.

Alternate embodiments of the invention will become apparent to those skilled in the art to which the present invention pertains without departing from its spirit and scope. Accordingly, the scope of the present invention is described by the appended claims and supported by the forgoing description.

What is claimed is:

1. A method for charging a plurality of batteries in more than one battery string to a desired voltage comprising the steps of:
coupling the current drawn from a battery of a given string with the current of another of the plurality of battery strings such that each string is coupled to another string to provide a combined string current;
drawing an equal string current from each of the plurality of batteries; and
redistributing the combined string current by providing a plurality of secondary charging currents to each of the plurality of batteries, wherein the size of the secondary current applied to a particular battery is inverse to the size of the voltage of the particular battery.

2. The method of claim 1 further comprising the step of regulating a combined string voltage of the battery string to a target voltage.

3. The method of claim 2 wherein the target voltage is equal to the sum of the desired voltage of the plurality of batteries.

4. The method of claim 1 wherein the step of redistributing the string current by providing a plurality of secondary charging currents to each of the plurality of batteries, wherein the size of the secondary current applied to a particular battery is inverse to the size of the voltage of the particular battery, comprises the step of providing a larger secondary current to batteries at a lower voltage than batteries at a comparatively higher voltage.

5. A method for equalizing the voltage of batteries in a plurality of battery strings to a desired voltage, comprising the steps of:
providing a transformer electrically connected to each of the plurality of battery strings;
drawing an equal string current from each battery in the battery string;
combining the string current drawn from each battery into a combined battery string;
providing the string current to of the transformers; and
utilizing each of the transformers to provide a secondary current to each of the plurality of batteries in its corresponding battery string, wherein the size of the secondary current provided to a particular battery is inverse to the size of the voltage of the particular battery.

6. The method of claim 5 wherein the step of providing the string current to the transformers comprises the step of providing the combined string current to an input winding of each of the transformers.

7. The method of claim 5 wherein the step of utilizing the transformers to provide a secondary current to each of the plurality of batteries comprises the step of inducing an output voltage in a plurality of output windings of each of the transformers, wherein each output winding of each of the plurality of output windings is parallel to one of the batteries of the corresponding battery string in an output circuit, such that the secondary current is induced to charge the battery in the output circuit.

8. The method of claim 5 further comprising the step of regulating a string voltage to a target voltage.

9. The method of claim 8 wherein the target voltage is equal to the sum of the desired voltage of each of the plurality of batteries.

10. A method for equalizing the voltage of a plurality of groups of batteries forming a combined battery string, comprising the steps of:
drawing an equal string current from each of the plurality of batteries;
providing the string current to an input winding of each of a plurality of transformers, each transformer corresponding to one of the groups of batteries;
inducing a voltage in the input winding of each of the transformers;
inducing an output voltage in a plurality of output windings of each of the transformers, wherein each of the output windings is connected in parallel with one of the plurality of batteries corresponding to a given transformer; and
providing a secondary current from each of the output windings to the corresponding battery, wherein the size of the secondary current provided to each battery is inverse to the size of the voltage of the battery.

11. The method of claim 10 further comprising the step of applying a charging current to the battery string from a charger such that a string voltage of the combined battery string is equal to a target voltage when the batteries are charged.

12. The method of claim 11 wherein the target voltage is equal to the sum of the desired voltage of the plurality of batteries.

13. A battery equalizer for equalizing the charge of a plurality of batteries in a combined battery string, wherein the combined battery string comprises a plurality of groups of batteries serially strung together, comprising:
an input winding of each of a plurality of transformers, each transformer corresponding to one of the groups of batteries, in connection with the combined battery string so as to receive an equal string current from each of the plurality of batteries of the combined battery string;
a plurality of output windings of each of the transformers, each of the output windings in parallel-connection in an output circuit with one of the batteries, wherein a turn ratio of each of the output windings is equivalent.

14. The battery equalizer of claim 13 wherein at least one bridging winding couples the batteries of one string to the batteries of at least one other string so that the batteries in all strings are equalized to the same voltage, the bridging winding being on the secondary side of one of the transformers and being in parallel-connection in an output circuit with a battery of the at least one other string.

15. The battery equalizer of claim 13 wherein one of the output windings of one of the plurality of transformers corresponding to a battery of a first of the groups of batteries is in parallel-connection in an output circuit with a battery of a second group of batteries, and wherein the output windings corresponding to said battery of a second of the groups of batteries is in parallel-connection with a battery of the first of the groups of batteries.

16. The battery equalizer of claim 13 further comprising a current regulator, for regulating the string current received by the input winding.

17. The battery equalizer of claim 13 wherein the transformer is a fly back transformer.

18. The battery equalizer of claim 13 further comprising a charger for providing a charging current to the battery string.

19. The battery equalizer of claim 18 wherein the charger regulates the string voltage of the battery string to a target voltage.

20. The battery equalizer of claim 19 wherein the target voltage is equal to the sum of the desired voltage of the plurality of batteries.

21. A system for charging a plurality of batteries, to a desired voltage comprising:
a plurality of batteries connected in a plurality of groups, eeach group comprising a battery string;
an input winding of each of a plurality of flyback transformer, each of the plurality of flyback transformers connected to one of the groups of battery strings such that a combined string current flows through the input windings; and
a plurality of output windings of each of the the transformers, each of the output windings connected in parallel to one of the plurality of batteries in an output circuit, wherein the turn ratios of the output windings are equal; and
a charger for regulating a charging current to the battery string such that the battery string is at a target voltage.

22. The system of claim 21 wherein the target voltage is equal to the sum of the desired voltage of the plurality of batteries.
